(19) United States
(12) Patent Application Publication
(10) Pub. No.: US 2006/0098238 A1
(43) Pub. Date: May 11, 2006

(54) On-demand activation of bluetooth sap

(75) Inventor: Otso Ylonen, Salo (FI)

Correspondence Address: William J. Barber;Ware, Fressola, Van Der Sluys & Adolphson LLP, Building Five, Bradford Green, 755 Main Street, P.O. Box 224, Monroe, CT, 06468, US

(73) Assignee: Nokia Corporation, doing business in Espoo, Finlan

(21) Appl. No.: 10/982,397

(22) Filed: Nov. 5, 2004

(51) Int. Cl. H04N 1/00

(52) U.S. Cl. 358/402

(57) ABSTRACT

The invention provides a method and system for coupling a first device to a second device having a module containing subscriber-related data therein, the data being usable and accessible by a user of the first device, wherein the activation of the usability and accessibility of the data is tied to “on-demand” user interaction in the first device in the form of an initiation of a communications session, such as making a phone call or data connection, or opening a communicator, or sending an email, or other suitable communications session. The activation may include the initiation of the phone call from a phonebook in the first device, an attachment by the user of an audio accessory such as a headset or a conference call stand, a physical opening by the user of the first device such as into a conference call mode, a request by the user for a cellular data connection, including starting an email application, launching a Web browser, or selecting “fetch messages” or “send now”.

### BACKGROUND OF THE INVENTION

1. Field Of Invention

The present invention relates to a method or system for coupling a first device to a cellular network via a second device having a module containing subscriber-related data therein that is usable and accessible by a user of the first device; and, more particularly, relates to a method or system for coupling a first mobile phone, user equipment, or other mobile terminal or device to a cellular or other suitable network via a second mobile phone, user equipment, or other mobile terminal or device having a Subscriber Identity Module (SIM) containing the subscriber-related data therein that is usable and accessible by the user of the first mobile phone, user equipment or other mobile terminal or device.

2. Description of Related Art

In the prior art, a method or system is known for coupling a first device to a cellular network via a second device having a module containing subscriber-related data therein that is usable and accessible by a user of the first device, as disclosed in WO 2004/057891 and WO 02/21867, both assigned to the assignee of the instant invention and hereby incorporated herein by reference. In particular, when the user has one SIM card for using with multiple mobile devices. One of the devices, for example, a small phone, is always with the user and the SIM card can be always kept inside of this device, which may be called “the server device”. When, and only when, another device, such as a Communicator or a Personal Digital Assistant (PDA), is used for communication, it will automatically take control of the SIM card in the server device. As described in WO 02/21867, the SIM card may be accessed by a data transfer between the devices that is done by exchanging Application Protocol Data Units (APDUs) with the server device acting as the mediator and being responsible for establishing and maintaining the physical connection with the SIM.

One disadvantage of this approach is that the activation of the usability and accessibility of the data is not based on the demand of the user.

### SUMMARY OF INVENTION

In its broadest sense, the present invention provides a new and unique method and system for coupling a first device to a cellular or other suitable network via a second device having a module containing subscriber-related data therein, the data being usable and accessible by a user of the first device, wherein the activation of the usability and accessibility of the data is tied to “on-demand” user interaction in the first device in the form of an initiation of a communications session. The initiation of a communications session may include making a phone call, or opening a data connection, or sending an email, or unfolding a keyboard, or opening a cover or flip. The connection may be terminated after the communications session has ended or a reasonable time-out period has expired. In operation, the present invention provides the user of the first device with “on-demand” activation and de-activation of the access and usage of the subscriber-related data in the module of the second device for coupling to the cellular or other suitable network.

The activation may be triggered by the initiation of a phone call from the phonebook in the first device, the attachment of an audio accessory such as a headset or a conference call stand, an action by the user of the first device that changes the state of the device physically, e.g. opening a flip to activate conference call mode, as well as an invocation of an application or a feature that requires a data connection, including starting an email application, launching a Web browser, or selecting a specific action within an application, like “fetch messages” or “send now”.

The activation initiated by the communications session includes initiation by software programs, including making a one-to-one call or conference call, launching or closing an application or activating or deactivating a function within the application, as well as by physical elements of the first device, including pressing a button or a lever, opening or closing a flip or slide mechanism, or joining or removing one or more modular parts or attachments. The physical elements may include either: pressing a tangent to enable coupling to the second device and open a speech connection, while depressing the tangent closes the speech connection; or opening a flip/cover of a phone to establish coupling to the second device, while closing of the flip/cover deactivates it; or detaching the first device from a docking station or a stand to enable coupling to the second device, i.e. activates the SIM access and puts the device into a “mobile access mode”, while attaching the first device to the docking station or the stand closes the connection, i.e. deactivates the SIM access and puts the device into a “desk operating mode” and possibly opening an alternative communications channel, e.g. an Ethernet or a USB connection; or some combination thereof.

In operation, the first device and the second device are paired together and a wireless connection is allowed to be established automatically. The wireless connection may be the known Bluetooth (BT) Subscriber Identity Module (SIM) Access Protocol (SAP) or other suitable wireless connection protocol, which is assumed to be activated when the paired devices come into close physical proximity, i.e. when the BT connection is available between them. In effect, the present invention expands the usage of BT SAP to more varied situations to allow rich interaction with different kinds of mobile terminals and applications.

The subscriber identity may be held within a SIM card, another suitable subscriber identity module or a software based identity storage.

The first and the second device may be any computing or communications device such as a mobile phone, a PDA, a communicator, a portable computer, a data collection device etc.

The present invention also provides a new and unique device such as a mobile phone or other suitable mobile terminal that couples to another device having such a module containing the subscriber-related data therein consistent with that discussed above, wherein the activation of the use and access of the data is tied to the “on-demand” user interaction in the device in the form of the initiation of such a communications session. In this embodiment, the device may include a client BT SAP module that responds to the user interaction in the form of the initiation of the communications session, and provides a client BT SAP module connection signal to a server BT SAP module in the other device requesting subscriber-related data. The other device responds to the client BT SAP module connection signal and provides a server BT SAP module connection signal containing the subscriber-related data.

The present invention also provides a computer program product with a program code that is stored on a machine readable carrier for carrying out the steps of the method described herein.

One advantage of the present invention is that it guarantees that the incoming communications come via the primary/server device and that the user-initiated communications can be done with a (secondary/client) device that best suits the need.

Another advantage of the present invention is that the access and use of the subscriber-related data of the second device is activated and deactivated “on-demand”.

### BRIEF DESCRIPTION OF THE DRAWING

FIG. 1 is a block diagram of a first device coupled to a cellular network via a second device according to the present invention.

### DETAILED DESCRIPTION OF THE INVENTION

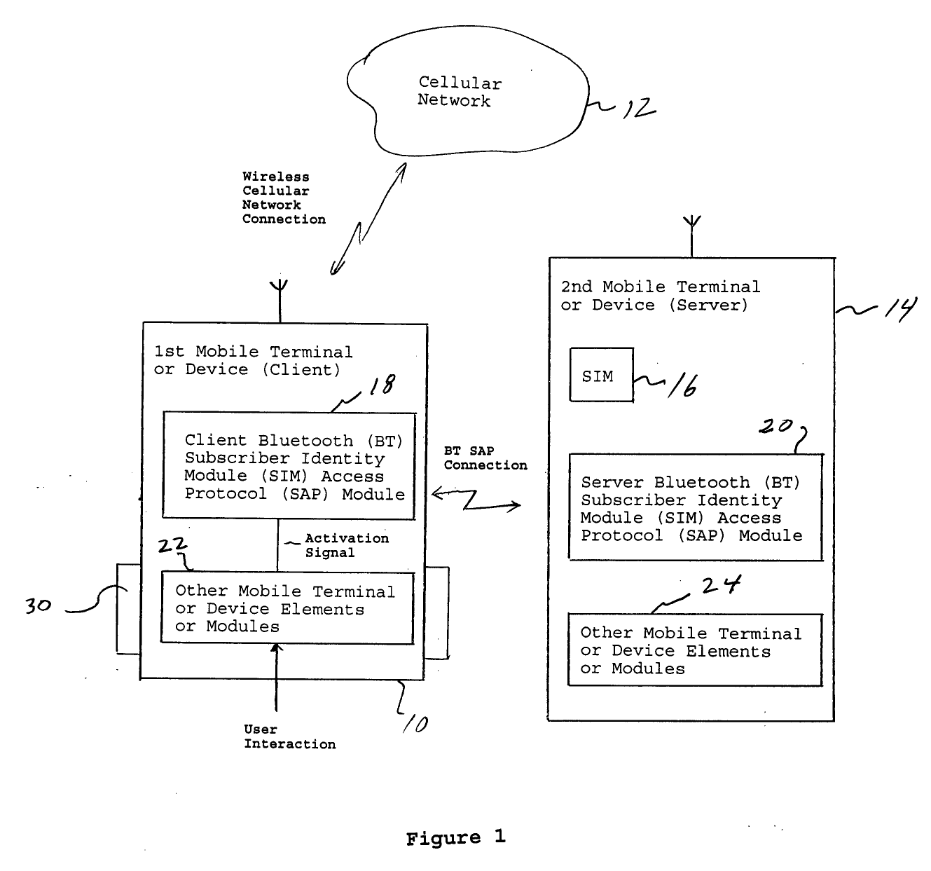

FIG. 1 shows a first device 10 for coupling to a cellular or other suitable network 12 via a second device 14 having a module 16 containing subscriber-related data therein, the data being usable and accessible by a user of the first device 10. According to the present invention, the activation of the usability and accessibility of the data is tied to a user interaction in the first device 10 in the form of an initiation of a communications session, such as making a phone call, or opening a data connection, or sending an email, or unfolding a keyboard, or opening a cover or flip, or other suitable communications session. Similarly, the connection between the first and second devices may be terminated after the communications session has ended or a reasonable time-out period has expired. In operation, the user of the first device 10 has “on-demand” activation and de-activation of the usability and accessibility of the subscriber-related data in the module 16 of the second device 14 for coupling to the cellular or other suitable network 12.

Examples of possible activation methods according to the present invention include: The initiation of the phone call from a phonebook in the first device 10, an attachment by the user of an audio accessory such as a headset or a conference call stand, a physical opening by the user of the first device 10 such as into a conference call mode, a request by the user for a cellular data connection, including starting an email application, launching a Web browser, or selecting “fetch messages” or “send now”. In operation, the first device 10 and the second device 14 are paired together, and a wireless connection is allowed to be established automatically, including a BT SAP or other suitable wireless connection. The scope of the invention is not intended to be limited to any particular type or kind of wireless connection protocol, and may include other wireless connection protocols now known or later developed in the future.

The activation initiated by the communications session may include user interactive initiation by software programs, including launching or closing an application or activating or deactivating a function within the application, as well as by physical elements of the first device 10, including pressing a button or a lever, opening or closing a flip or slide mechanism, or joining or removing one or more modular parts or attachments. The physical elements may include either: pressing a tangent to enable coupling to the second device and open a speech connection, and depressing the tangent closes the speech connection; or opening a flip/cover of a phone to establish coupling to the second device 14, and closing of the flip/cover deactivates it; or detaching the first device 10 from a docking station or a stand generally indicated as 30 to enable coupling to the second device 14, and attaching the first device 10 to the docking station or the stand 30 closes the connection; or some combination thereof. The user interacts with one or more of these physical elements, including elements mobile terminal or device elements that form part of element 22 discussed below, to initiate the communications sessions. In order to make the use of the invention, an application programming interface (API) may be made available for the developers of mobile devices and applications. In devices that support multi-tasking, the API may need to take care of the SIM access connection requests that originate from user actions within different application programs. The scope of the invention is not intended to be limited to the manner or kind of user interaction that activates the communications session.

By way of example, the module 16 is shown and described herein as a Subscriber Identity Module (SIM) that is known in the art, but may include other suitable subscriber identity module now known or later developed in the future. The scope of the invention is not intended to be limited to the type or kind of module 16 containing the subscriber-related data.

By way of example, the wireless connection protocol is shown and described as a BT SAP wireless connection that is known in the art, but may include other suitable wireless connection protocol now known or later developed in the future. The scope of the invention is not intended to be limited to the type or kind of wireless connection or protocol for coupling the two devices 10 and 14.

The first and second device 10 and 14 may include a mobile phone, user equipment, mobile terminal, a PDA, a communicator, which are all known in the art, but may include other types or kinds of devices now known or later developed in the future. The scope of the invention is not intended to be limited to any particular type or kind of device.

In FIG. 1, the first device 10 has a client Bluetooth Subscriber Identity Access Protocol Module 18 that responds to the user interaction, and provides a client BT SAP connection signal to a server Bluetooth (BT) Subscriber Identity Module (SIM) Access Protocol (SAP) Module 20 of the second device 14 requesting subscriber-related data. The second device 14 responds to the client BT SAP connection signal and provides a server BT SAP containing the subscriber-related data.

The functionality of the modules 18 and 20 shown in FIG. 1 may be implemented using hardware, software, firmware, or a combination thereof. In a typical software implementation, the modules 18 and 20 would be one or more microprocessor-based architectures having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation. The scope of the invention is not intended to be limited to any particular implementation using technology known or later developed in the future.

### Other Mobile Terminal or Device Elements or Modules 22, 24

The devices 12 and 14 respectively may also include other mobile terminal or device elements or modules 22, 24 that are known in the art, including a keyboard having one or more keys or control buttons; keyboard control module; an audio accessory (e.g. headphone or ear plug); an audio accessory control module; wireless connection protocol module (including a BT SAP connection module); flip, cover or slide mechanism(s); flip, cover or slide mechanism control module(s); module parts or attachments (including conference stand, docking station, etc.); modular parts or attachments control module; a display; a display control module; a memory module; input/output modules; a processor or control module; etc. As discussed above, the user may physically interact with one or more of these elements in the first device 10, such as by touching a key on a keyboard or a control button on the device; by inserting an audio accessory such as a headphone or ear plug); by opening a flip, cover or moving a slide mechanism(s); by attaching the device to a module part or attachment such as a conference stand, docking station, etc.) to initiate the communications sessions. If such an interaction occurs or happens, then the module 22 will provide an activation signal to the module 18 so as to activate the usability and accessibility of the data in the SIM 16 consistent with that discussed above.

### SCOPE OF THE INVENTION

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

I claim:

1. A method for coupling a first device to a cellular or other suitable network via a second device having a module containing subscriber-related data therein, the data being usable and accessible by a user of the first device, characterized in that
the activation of the usability and accessibility of the data is tied to “on-demand” user interaction in the first device in the form of an initiation of a communications session.

2. A method according to claim 1, wherein the initiation of the phone call is from a phonebook in the first device.

3. A method according to claim 1, wherein the activation includes an attachment by the user of an audio accessory such as a headset or a conference call stand.

4. A method according to claim 1, wherein the activation includes a physical opening by the user of the first device such as into a conference call mode.

5. A method according to claim 1, wherein the activation includes a request by the user for a cellular data connection, including starting an email application, launching a Web browser, or selecting “fetch messages” or “send now”.

6. A method according to claim 1, wherein the connection is terminated after the communications session has ended or a reasonable time-out period has expired.

7. A method according to claim 1, wherein the first device and the second device have been paired together and a wireless connection is allowed to be established automatically.

8. A method according to claim 7, wherein the wireless connection is Bluetooth (BT) Subscriber Identity Module (SIM) Access Protocol (SAP).

9. A method according to claim 1, wherein the activation initiated by the communications session includes initiation by software programs, including launching or closing an application or activating or deactivating a function within the application.

10. A method according to claim 1, wherein the activation initiated by the communications session includes initiation by physical elements of the first device, including pressing a button or a lever, opening or closing a flip or slide mechanism, or joining or removing one or more modular parts or attachments.

11. A method according to claim 10, wherein the physical elements include either:
pressing a tangent to enable coupling to the second device and open a speech connection, and depressing the tangent closes the speech connection; or
opening a flip/cover of a phone to establish coupling to the second device, and closing of the flip/cover deactivates it; or
detaching the first device from a docking station or a stand to enable coupling to the second device, and attaching the first device to the docking station or the stand closes the connection; or
some combination thereof.

12. A method according to claim 1, wherein the module is a Subscriber Identity Module (SIM).

13. A system for coupling a first device to a cellular or other suitable network via a second device having a module containing subscriber-related data therein, the data being usable and accessible by a user of the first device, characterized in that
the activation of the usability and accessibility of the data is tied to “on-demand” user interaction in the first device in the form of an initiation of a communications session.

14. A system according to claim 13, wherein the initiation of the phone call is from a phonebook in the first device.

15. A system according to claim 13, wherein the activation includes an attachment by the user of an audio accessory such as a headset or a conference call stand.

16. A system according to claim 13, wherein the activation includes a physical opening by the user of the first device such as into a conference call mode.

17. A system according to claim 13, wherein the activation includes a request by the user for a cellular data connection, including starting an email application, launching a Web browser, or selecting “fetch messages” or “send now”.

18. A system according to claim 13, wherein the connection is terminated after the communications session has ended or a reasonable time-out period has expired.

19. A system according to claim 13, wherein the first device and the second device have been paired together and a wireless connection is allowed to be established automatically.

20. A system according to claim 19, wherein the wireless connection is Bluetooth (BT) Subscriber Identity Module (SIM) Access Protocol (SAP).

21. A system according to claim 13, wherein the activation initiated by the communications session includes initiation by software programs, including launching or closing an application or activating or deactivating a function within the application.

22. A system according to claim 13, wherein the activation initiated by the communications session includes initiation by physical elements of the first device, including pressing a button or a lever, opening or closing a flip or slide mechanism, or joining or removing one or more modular parts or attachments.

23. A system according to claim 22, wherein the physical elements include either:
pressing a tangent to enable coupling to the second device and open a speech connection, and depressing the tangent closes the speech connection; or
opening a flip/cover of a phone to establish coupling to the second device, and closing of the flip/cover deactivates it; or
detaching the first device from a docking station or a stand to enable coupling to the second device, and attaching the first device to the docking station or the stand closes the connection; or
some combination thereof.

24. A system according to claim 13, wherein the module is a Subscriber Identity Module (SIM).

25. A first device for coupling to a cellular or other suitable network via a second device having a module containing subscriber-related data therein, the data being usable and accessible by a user of the first device, characterized in that
the activation of the usability and accessibility of the data is tied to “on-demand” user interaction in the first device in the form of an initiation of a communications session.

26. A first device according to claim 25, wherein the initiation of the phone call is from a phonebook in the first device.

27. A first device according to claim 25, wherein the activation includes an attachment by the user of an audio accessory such as a headset or a conference call stand.

28. A first device according to claim 25, wherein the activation includes a physical opening by the user of the first device such as into a conference call mode.

29. A first device according to claim 25, wherein the activation includes a request by the user for a cellular data connection, including starting an email application, launching a Web browser, or selecting “fetch messages” or “send now”.

30. A first device according to claim 25, wherein the connection is terminated after the communications session has ended or a reasonable time-out period has expired.

31. A first device according to claim 25, wherein the first device and the second device have been paired together and a wireless connection is allowed to be established automatically.

32. A first device according to claim 31, wherein the wireless connection is Bluetooth (BT) Subscriber Identity Module (SIM) Access Protocol (SAP).

33. A first device according to claim 25, wherein the activation initiated by the communications session includes initiation by software programs, including launching or closing an application or activating or deactivating a function within the application.

34. A first device according to claim 25, wherein the activation initiated by the communications session includes initiation by physical elements of the first device, including pressing a button or a lever, opening or closing a flip or slide mechanism, or joining or removing one or more modular parts or attachments.

35. A first device according to claim 34, wherein the physical elements include either:
pressing a tangent to enable coupling to the second device and open a speech connection, and depressing the tangent closes the speech connection; or
opening a flip/cover of a phone to establish coupling to the second device, and closing of the flip/cover deactivates it; or
detaching the first device from a docking station or a stand to enable coupling to the second device, and attaching the first device to the docking station or the stand closes the connection; or
some combination thereof.

36. A first device according to claim 25, wherein the module is a Subscriber Identity Module (SIM).

37. A first device according to claim 25, wherein the first device has a client Bluetooth Subscriber Identity Access Protocol Module that responds to the user interaction in the form of the initiation of the communications session, and provides a client Bluetooth (BT) Subscriber Identity Module (SIM) Access Protocol (SAP) Module connection signal to a server Bluetooth (BT) Subscriber Identity Module (SIM) Access Protocol (SAP) Module of the second device requesting subscriber-related data.

38. A first device according to claim 37, wherein the second device responds to the client Bluetooth (BT) Subscriber Identity Module (SIM) Access Protocol (SAP) Module connection signal and provides a server Bluetooth (BT) Subscriber Identity Module (SIM) Access Protocol (SAP) Module connection signal containing the subscriber-related data.

39. A first device according to claim 25, wherein the activation initiated by the communications session is programmable.

40. A system according to claim 13, wherein the first device responds to the user interaction, and provides a client Bluetooth (BT) Subscriber Identity Module (SIM) Access Protocol (SAP) Module connection signal to the second device requesting subscriber-related data.

41. A system according to claim 40, wherein the second device responds to the client Bluetooth (BT) Subscriber Identity Module (SIM) Access Protocol (SAP) Module connection signal and provides the subscriber-related data.

42. A system according to claim 13, wherein the activation initiated by the communications session is programmable.

43. A method according to claim 1, wherein the first device responds to the user interaction, and provides a client Bluetooth (BT) Subscriber Identity Module (SIM) Access Protocol (SAP) Module connection signal to the second device requesting subscriber-related data.

44. A system according to claim 43, wherein the second device responds to the client Bluetooth (BT) Subscriber Identity Module (SIM) Access Protocol (SAP) Module connection signal and provides the subscriber-related data.

45. A method according to claim 1, wherein the activation initiated by the communications session is programmable.

46. A method according to claim 1, wherein the method further comprises implementing the step of the method via a computer program running in a processor or controller in a device.

47. A computer program product with a program code, which program code is stored on a machine readable carrier, for carrying out steps of a method for activating the usability and accessibility of the data tied to the user interaction in the first device in the form of the initiation of the communications session, when a computer program is run in a processor or control module of a device.

48. A method according to claim 1, wherein the initiation of the communications session includes making a phone call, or opening a data connection, or sending an email, or unfolding a keyboard, or opening a cover or flip.

49. A system according to claim 13, wherein the initiation of the communications session includes making a phone call, or opening a data connection, or sending an email, or unfolding a keyboard, or opening a cover or flip.

50. A first device according to claim 25, wherein the initiation of the communications session includes making a phone call, or opening a data connection, or sending an email, or unfolding a keyboard, or opening a cover or flip.
